(19) United States
(12) Patent Application Publication
(10) Pub. No.: US 2021/0251220 A1
(43) Pub. Date: Aug. 19, 2021

(54) LICE ELIMINATOR

(71) Applicants: OSAKA PHARMACEUTICAL CO., LTD., Higashiosaka-shi, Osaka (JP); DAINIHON JOCHUGIKU CO., LTD., Osaka-shi, Osaka (JP)

(72) Inventor: Naoko IKEDA, Higashiosaka-shi (JP)

(73) Assignees: Osaka Pharmaceutical Co., Ltd., Higashiosaka-shi, Osaka (JP); Dainihon Jochugiku Co., Ltd., Osaka-shi, Osaka (JP)

(21) Appl. No.: 17/041,657

(22) PCT Filed: Mar. 28, 2019
(86) PCT No.: PCT/JP2019/013505

§ 371 Date: Jan. 28, 2021

(30) Foreign Application Priority Data
Apr. 2, 2018 (JP) 2018-070837

(51) Int. Cl. A01N 25/30; A01N 25/02

(52) U.S. Cl. CPC A01N 25/30; A01N 2300/00; A01N 25/02

(57) ABSTRACT

Problem to be Solved

An object of the present invention is to provide an eliminator that exterminates lice by blocking the lice from the outside, for example, by sealing the spiracle of the louse, that can be used on humans, animals, clothes, and the like, and that is easy to adhere to and spread out over the outer skin of lice without being repelled by the outer skin when brought into contact with the lice.

Solution

The problem can be solved by a lice eliminator or the like which is characterized in that a louse precipitation rate which is a proportion in percentage of the lice precipitating completely into the lice eliminator with respect to the lice dropped onto the lice eliminator when multiple lice have been dropped is 50 to 100%.

### TECHNICAL FIELD

The present invention relates to a hygiene pest eliminator that is excellent in the safety and practical utility, and has an effect of the extermination of lice.

### BACKGROUND ART

Conventionally, in order to prevent the damage from lice and to prevent the spread of the damage, a hygiene pest eliminator for use by applying the eliminator to the humans and animals has been known. In general, lice are often parasitic on nursery school children, kindergarten children, children in the lower grades of elementary school, and the like, and phenothrin that is a pyrethroid-based insecticide with solid safety is known as an agent that can be used for humans and animals. However, in recent years, the presence of a hygiene pest that is resistant to an agent acting on the nerve cells of the pest has been reported, and therefore, a preparation, which has a mechanism of action different from that of the pyrethroid-based insecticide and has the safety in almost the same degree as that of the currently used phenothrin preparation, has been demanded.

For example, Patent Literature 1 discloses a lice eliminator comprising at least one of a higher alcohol having 9 to 24 carbon atoms or a fatty acid having 1 to 22 carbon atoms.

### CITATION LIST

### Patent Literature

Patent Literature 1: Japanese Patent Laid-Open No. 2012-031169

### SUMMARY OF INVENTION

### Technical Problem

However, with respect to the lice eliminator disclosed in Patent Literature 1, the lice eliminator is repelled by the outer skin of a louse and does not adhere to the louse so as to wrap around the louse when brought into contact with the louse in order to exterminate the louse, and as a result, the extermination effect by blocking the louse from the outside, for example, by sealing the spiracle of the louse has not been sufficiently exerted in some cases.

In view of this, an object of the present invention is to provide an eliminator that exterminates a louse by blocking the louse from the outside, for example, by sealing the spiracle of the louse, that can be used for humans, animals, clothes, and the like, and that is easy to adhere to and spread out over the outer skin of the louse without being repelled by the outer skin when brought into contact with the louse.

### Solution to Problem

[1] That is, the lice eliminator according to the present invention is a lice eliminator easy to adhere to and spread out over the outer skin of a louse without being repelled by the outer skin, wherein

a louse precipitation rate which is a proportion in percentage of lice precipitating completely into the lice eliminator with respect to lice dropped onto the lice eliminator when a plurality of lice is dropped is 50 to 100%, wherein the lice eliminator contains a spreading component having a contact angle of 1 to 60?, and wherein the spreading component is at least one of a cationic surfactant, an anionic surfactant, an amphoteric surfactant, or a nonionic surfactant.

Further, the lice eliminator is the lice eliminator, wherein the lice eliminator contains a spreading component having a contact angle of 1 to 60°.

Further, the lice eliminator is the lice eliminator, wherein the spreading component is a surfactant.

Further, the lice eliminator is the lice eliminator, wherein the spreading component is at least one of a cationic surfactant, an anionic surfactant, an amphoteric surfactant, or a nonionic surfactant.

[2] Further, the lice eliminator is the lice eliminator according to the above [1], wherein the spreading component is two selected from an anionic surfactant, an amphoteric surfactant, or a nonionic surfactant.

[3] Further, the lice eliminator is the lice eliminator according to the above [1], in which the spreading component is an anionic surfactant and an amphoteric surfactant.

[4] Further, the lice eliminator is the lice eliminator according to the above [1], in which the spreading component is contained by 0.1 to 80% by weight.

### Advantageous Effects of Invention

According to the lice eliminator of the present invention, the lice eliminator can be used for humans, animals, clothes, and the like, is easy to adhere to and spread out over the outer skin of a louse without being repelled by the outer skin when brought into contact with the louse, and can exterminate the louse by blocking the louse from the outside, for example, by sealing the spiracle of the louse.

### DESCRIPTION OF EMBODIMENTS

Hereinafter, the embodiment relating to the lice eliminator of the present invention will be described in detail. Note that in a case where there is an expression indicating a range in the description, the upper limit and the lower limit are included in the range.

The present invention is a lice eliminator having a louse precipitation rate of 50 to 100%, wherein the precipitation rate is an indicator of the easiness of being taken onto a louse. The louse precipitation rate is expressed as a proportion in percentage that is obtained by dividing the number of the lice of which the head, chest, and abdomen have been all precipitating completely into a liquid of the lice eliminator by the total number of the lice dropped onto the liquid when a plurality of lice is dropped onto the liquid surface of the lice eliminator, and is indicated by equation (1).

{(The number of lice precipitating into the liquid)/(The total number of lice dropped onto the liquid)}×100 (1)

As described above, the louse precipitation rate is used as an indicator showing the easiness of taking the eliminator onto a louse, for example, the easiness of adhering to and spreading out over the outer skin of a louse when the eliminator is brought into contact with the louse. In the present invention, it is preferred that the louse precipitation rate is 50 to 100%. When the louse precipitation rate is in this rang, the eliminator is easily taken onto a louse, for example, easily adheres to and spreads out over the outer skin of a louse, without being repelled by the outer skin when brought into contact with the louse, and the effect of exterminating a louse by blocking the louse from the outside, for example, by sealing the spiracle of the louse becomes high.

Further, as the type of the louse that can be used in measuring the louse precipitation rate, a variety of lice can be used, and it is preferred to use a body louse, a head louse, and a crab louse, which are parasitic on human beings.

The present invention is a lice eliminator characterized by further containing a spreading component having a contact angle of 1 to 60°. In general, the contact angle means an angle formed by a liquid surface and a solid surface when the solid surface is in contact with the liquid or the like, and is used as an indicator of the wettability on the solid surface. The smaller the value of this contact angle is, the easier it is to spread the wetting on the solid surface.

It is preferred that the contact angle of the spreading component to be mixed in the lice eliminator according to the present invention is 1 to 60°. When the contact angle on a solid surface of the spreading component to be mixed in the lice eliminator according to the present invention is in this range, the lice eliminator spreads wet and is easily taken onto a louse, for example, easily adheres to and spreads out over the outer skin of a louse, without being repelled by the outer skin when brought into contact with the louse, and the effect of exterminating a louse by blocking the louse from the outside, for example, by sealing the spiracle of the louse becomes higher. It is preferred that the contact angle of the spreading component contained in the lice eliminator of the present invention is measured by a θ/2 method or the like in accordance with the method described in JIS R3257 (1999) or the like. When the spreading component is soluble in water and is solid, the contact angle as an aqueous solution, for example, at 10% by weight or the like is measured. When the spreading component is not soluble in water and is in a liquid state, the contact angle is measured as the stock solution, and when the spreading component is soluble in water and is in a liquid state, the contact angle is measured as the stock solution or an aqueous solution at 10% by weight or the like.

It is preferred that the spreading component to be mixed in the lice eliminator according to the present invention is a surfactant.

It is preferred that in the surfactant of the spreading component to be mixed in the lice eliminator according to the present invention, at least one of a cationic surfactant, an anionic surfactant, an amphoteric surfactant, and a nonionic surfactant is mixed.

The cationic surfactant to be used in the present invention is a surfactant having a cationic hydrophilic group, and among them, a quaternary ammonium salt type, an amine salt type, or the like is preferred, and not only a compound having a purity of 100% in a liquid or solid state, but also an aqueous solution obtained by diluting the compound with a predetermined amount of water may be used.

The quaternary ammonium salt-type cationic surfactant preferably has as four substituents, a linear or branched hydrocarbon group having 1 to 22 carbon atoms, an aromatic group, and a combination thereof, and has a halide ion such as a chloride ion, or a bromide ion is provided as a counter anion. Further, the hydrocarbon group may be a linear or branched and saturated or unsaturated group having 1 to 18 carbon atoms, and the counter anion may be a hydroxide ion, a phosphorus ion, or a boron ion. Specifically, lauryl trimethyl ammonium chloride, benzyl trimethyl ammonium chloride, benzyl triethyl ammonium bromide, tetrabutylammonium hydroxide, tetramethylammonium bromide, tetrabutylammonium iodide, benzyl tributyl ammonium chloride, tetrabutylammonium hexafluorophosphate, tetrabutylammonium tetrafluoroborate, alkyl dimethyl ammonium chloride, or the like can be used.

As the amine salt-type cationic surfactant, coconut amine acetate, stearylamine acetate, or the like can be used.

The anionic surfactant to be used in the present invention is a surfactant having an anionic hydrophilic group and has agents of amino acid-type activity, and among them, at least one selected from a carboxylic acid type, a sulfonic acid type, a sulfate ester type, and a phosphate ester type is preferred, and not only a compound having a purity of 100% in a liquid or solid state, but also an aqueous solution obtained by diluting the compound with a predetermined amount of water may be used.

As the carboxylic acid-type anionic surfactant, a salt of a carboxyl group having a main chain of a linear or branched hydrocarbon group having 1 to 22 carbon atoms and an acyl group, a polyoxyalkylene group, an aromatic group and a combination thereof, with a metal such as an alkali metal, or an alkaline earth metal is preferred. Further, the hydrocarbon group may be a linear or branched and saturated or unsaturated group having 1 to 18 carbon atoms. Specifically, sodium laurate, sodium stearate, sodium laureth-6 carboxylate (sodium polyoxyethylene(4.5) lauryl ether acetate), lauroylsarcosine sodium, sodium octanoate, sodium decanoate, sodium myristate, sodium palmitate, coconut oil fatty acid (C8 to 18) sarcosine sodium, coconut oil fatty acid potassium, or the like can be used.

As the sulfonic acid-type anionic surfactant, a salt of a sulfonyl group having a main chain of a linear or branched hydrocarbon group having 1 to 22 carbon atoms and an acyl group, a polyoxyalkylene group, an aromatic group and a combination thereof, with a metal such as an alkali metal, or an alkaline earth metal is preferred. Further, the hydrocarbon group may be a linear or branched and saturated or unsaturated group having 1 to 18 carbon atoms. Specifically, sodium lauryl sulfoacetate, sodium 1-hexanesulfonate, sodium 1-octanesulfonate, sodium 1-decanesulfonate, sodium 1-dodecanesulfonate, sodium toluenesulfonate, sodium cumenesulfonate, sodium naphthalene sulfonate, disodium naphthalene disulfonate, trisodium naphthalene trisulfonate, sodium alpha olefin sulfonate, sodium dodecylbenzenesulfonate, or the like can be used.

As the sulfate ester-type anionic surfactant, a salt of a sulfate group having a main chain of a linear or branched hydrocarbon group having 1 to 22 carbon atoms and an acyl group, a polyoxyalkylene group, an aromatic group and a combination thereof, with a metal such as an alkali metal, or an alkaline earth metal is preferred. Further, the hydrocarbon group may be a linear or branched and saturated or unsaturated group having 1 to 18 carbon atoms. Specifically, sodium lauryl sulfate, sodium myristyl sulfate, sodium laureth sulfate (sodium polyoxyethylene(3) lauryl ether sulfate), sodium cetyl sulfate, sodium cocoglyceryl sulfate (sodium (hardened coconut oil fatty acid) glyceryl sulfate), triethanolamine lauryl sulfate, ammonium lauryl sulfate, triethanolamine laureth sulfate, or the like is preferred.

As the phosphate ester-type anionic surfactant, a salt of a phosphate group having a main chain of a linear or branched hydrocarbon group having 1 to 22 carbon atoms and an acyl group, a polyoxyalkylene group, an aromatic group and a combination thereof, with a metal such as an alkali metal, or an alkaline earth metal is preferred. Further, the hydrocarbon group may be a linear or branched and saturated or unsaturated group having 1 to 18 carbon atoms. Specifically, sodium lauryl phosphate, sodium polyoxyethylene cetyl ether phosphate (sodium polyoxyethylene(5) cetyl ether phosphate), lauryl phosphoric acid, potassium lauryl phosphate, or the like can be used.

The amphoteric surfactant to be used in the present invention is a surfactant having both anionic and cationic hydrophilic groups, and among them, at least one selected from an amine oxide type, and a betaine type is preferred, and not only a compound having a purity of 100% in a liquid or solid state, but also an aqueous solution obtained by diluting the compound with a predetermined amount of water may be used.

As the amine oxide-type amphoteric surfactant, an amine oxide group having a main chain of a linear or branched hydrocarbon group having 1 to 22 carbon atoms and an acyl group, a polyoxyalkylene group, an aromatic group and a combination thereof is preferred. Further, the hydrocarbon group may be a linear or branched and saturated or unsaturated group having 1 to 18 carbon atoms. Specifically, lauryldimethylamine oxide, alkyl (having 8 to 18 carbon atoms) dimethylamine oxide (N,N-dimethyl alkyl (C8-18) amine oxide), coconut alkyl dimethyl amine oxide, decyl dimethyl amine oxide, myristyl dimethyl amine oxide, dihydroxyethyl lauryl amine oxide, oleyl dimethyl amine oxide, or the like can be used.

As the betaine-type amphoteric surfactant, a compound that has a main chain of a linear or branched hydrocarbon group having 1 to 22 carbon atoms and an acyl group, a polyoxyalkylene group, an aromatic group and a combination thereof, and has a positive charge and a negative charge at the positions that are not adjacent to each other in the one molecule, and has no electric charge as the whole of molecule is preferred. Further, the hydrocarbon group may be a linear or branched and saturated or unsaturated group having 1 to 18 carbon atoms. Specifically, lauryldimethylaminoacetic acid betaine, lauryl hydroxy sulfobetaine, stearyldimethylaminoacetic acid betaine, dodecyl aminomethyl dimethyl sulfopropyl betaine, coconut oil fatty acid (C8-18) amidopropyl betaine, 2-alkyl-N-carboxymethyl-N-hydroxyethyl imidazolinium betaine, lauric acid amidopropyl betaine, or the like can be used.

The nonionic surfactant to be used in the present invention is a surfactant having a hydrophilic group that does not ionize when dissolved in water, and among them, at least one selected from an ester type, an ether type, and an ester-ether type is preferred, and not only a compound having a purity of 100% in a liquid or solid state, but also an aqueous solution obtained by diluting the compound with a predetermined amount of water may be used.

As the ester-type nonionic surfactant, a compound obtained from a carboxylic acid having a main chain of a linear or branched hydrocarbon group having 1 to 22 carbon atoms and an acyl group, an aromatic group and a combination thereof and a polyhydric alcohol is preferred. Further, the hydrocarbon group may be a linear or branched and saturated or unsaturated group having 1 to 18 carbon atoms. Specifically, a sorbitan fatty acid ester such as sorbitan monolaurate, sorbitan monopalmitate, sorbitan monostearate, or sorbitan distearate, a glycerin fatty acid ester such as glycerin monolaurate, glycerin monopalmitate, glycerin monostearate, or glycerin distearate can be used.

As the ether-type nonionic surfactant, a compound obtained from a monohydric alcohol having a main chain of a linear or branched hydrocarbon group having 1 to 22 carbon atoms and an acyl group, an aromatic group and a combination thereof, and a polyhydric alcohol is preferred. Further, the hydrocarbon group may be a linear or branched and saturated or unsaturated group having 1 to 18 carbon atoms. Specifically, a polyoxyethylene alkyl ether such as polyoxyethylene lauryl ether, polyoxyethylene cetyl ether, polyoxyethylene stearyl ether, polyoxyethylene oleyl ether, polyoxyethylene myristyl ether, polyoxyethylene octyldodecyl ether, or polyoxyethylene polyoxypropylene glycol, or polyoxyethylene alkylamine can be used.

As the ester-ether type nonionic surfactant, a compound obtained from a carboxylic acid having a main chain of a linear or branched hydrocarbon group having 1 to 22 carbon atoms and an acyl group, an aromatic group and a combination thereof, and a polyalkylene oxide or a polyhydric alcohol to which a polyalkylene oxide is added is preferred. Further, the hydrocarbon group may be a linear or branched and saturated or unsaturated group having 1 to 18 carbon atoms. Specifically, a polyoxyethylene sorbitan fatty acid ester such as polyoxyethylene sorbitan monolaurate, polyoxyethylene sorbitan monopalmitate, or polyoxyethylene sorbitan monooleate, a polyoxyethylene fatty acid ester such as polyethylene glycol monolaurate, or polyethylene glycol monostearate, a polyoxyethylene glycerin fatty acid ester such as polyoxyethylene glycerin monolaurate, polyoxyethylene glycerin monopalmitate, or polyoxyethylene glycerin monooleate, or the like can be used.

The cationic surfactant, the anionic surfactant, the amphoteric surfactant, and the nonionic surfactant may be used singly alone or in combination of two or more. Further, among them, two selected from the anionic surfactant, the amphoteric surfactant, and the nonionic surfactant are preferred, and it is more preferred to use the anionic surfactant and the amphoteric surfactant in combination.

Each surfactant of the cationic surfactant, the anionic surfactant, the amphoteric surfactant, and the nonionic surfactant, which is used as a spreading component, is mixed in the lice eliminator according to the present invention preferably at 0.1 to 80% by weight, more preferably at 0.5 to 50% by weight, and most preferably at 1 to 35% by weight. When the mixing ratio of each surfactant is in the above range, the lice eliminator is easy to adhere to and spread out over the outer skin of a louse without being repelled by the outer skin when brought into contact with the outer skin of the louse, and has a high extermination effect, and further, the lice eliminator can be easily washed off with water after use.

In addition, in the present invention, an alcohol having a main chain of a linear or branched hydrocarbon group having 1 to 22 carbon atoms and an acyl group, a polyoxyalkylene group, an aromatic group and a combination thereof can be mixed. Further, the hydrocarbon group may be a linear or branched and saturated or unsaturated group having 1 to 18 carbon atoms. For example, ethanol, n-butyl alcohol, isobutyl alcohol, sec-butyl alcohol, tert-butyl alcohol, hexanol, lauryl alcohol, myristyl alcohol, palmityl alcohol, stearyl alcohol, isostearyl alcohol, oleyl alcohol, linoleyl alcohol, behenyl alcohol, or the like can be used. In this regard, the above alcohol may be used singly alone or in combination of two or more.

Further, in order to prevent corrosion such as deterioration due to oxidation of a preparation, an antioxidant such as vitamin C (ascorbic acid), vitamin E (α-tocopherol), BHT (butyl hydroxytoluene), BHA (butylated hydroxyanisole), sorbic acid, potassium sorbate, or sodium sulfite can be used. In addition, paraoxybenzoic acid ester or the like can also be used for the purpose of corrosion prevention. Further, dipotassium glycyrrhizinate or the like can also be added for the purpose of anti-inflammatory effect and the like. Moreover, a phosphate buffer solution or the like can also be added for the purpose of adjusting the pH of a preparation.

Furthermore, L-menthol in order to give a refreshing feeling and various fragrances in order to give a scent can be added.

In the present invention, an insecticide may or may not be used, the use of an insecticide is not prevented, and various insecticides such as a pyrethroid-based insecticide, a neonicotinoid-based insecticide, and a macrolide-based insecticide can be added. As the pyrethroid-based insecticide, for example, allethrin, tetramethrin, prallethrin, phenothrin, resmethrin, cyphenothrin, permethrin, cypermethrin, deltamethrin, tralomethrin, cyfluthrin, furamethrin, imiprothrin, etofenprox, fenvalerate, fenpropathrin, silafluofen, terallethrin, bifenthrin, empenthrin, pyrethrin, or the like is preferred. In this regard, the above pyrethroid-based compound may be used singly alone or in combination of two or more.

As the neonicotinoid-based insecticide, for example, imidacloprid, dinotefuran, or the like is preferred.

As the macrolide-based insecticide, for example, ivermectin, emamectin, or the like is preferred.

### EXAMPLES

Hereinafter, Examples of the present invention will be specifically described. Note that the present invention should not be limited to the following Examples.

[Contact Angle of Spreading Component)

A 10% by weight aqueous solution of each spreading component was prepared, and the contact angle when a droplet of the aqueous solution was put on a stainless steel plate was measured with a contact angle meter (CAX-150 manufactured by Kyowa Interface Science Co., Ltd.) by a θ/2 method in accordance with the method described in JIS R3257 (1999).

These results are shown in Table 1.

TABLE 1

| | | | Contact |
|---|---|---|---|
| Sample | | | angle (°) |
| No. | Compound name | Type | of agent |
| 1 | Sodium dodecylbenzenesulfonate | Anionic | 25 |
| | | surfactant | |
| 2 | Coconut oil fatty acid potassium | Anionic | 53 |
| | liquid + glycerin | surfactant | |
| 3 | Sodium lauryl sulfate | Anionic | 38 |
| | | surfactant | |
| 4 | Lauryl trimethyl ammonium chloride | Cationic | 36 |
| | | surfactant | |
| 5 | Coconut amine acetate | Cationic | 34 |
| | | surfactant | |
| 6 | Alkyl (having 8 to 18 carbon atoms) | Amphoteric | 37 |
| | dimethylamine oxide | surfactant | |
| 7 | 2-Alkyl-N-carboxymethyl-N- | Amphoteric | 42 |
| | hydroxyethyl imidazolinium betaine | surfactant | |
| 8 | Polyoxyethylene lauryl ether | Nonionic | 38 |
| | | surfactant | |
| 9 | Polyethylene glycol monolaurate | Nonionic | 34 |
| | | surfactant | |
| 10 | Monolauric acid polyethylene glycol | Nonionic | 39 |
| | | surfactant | |
| 11 | N-Coconut oil fatty acid acyl-L- | Anionic | 61 |
| | alanine sodium solution | surfactant | |
| 12 | Sodium methyl cocoyl taurate | Cationic | 62 |
| | | surfactant | |
| 13 | Polyoxyethylene hydrogenated castor | Nonionic | 73 |
| | oil (40E.O.) | surfactant | |
| 14 | Polypropylene glycol | Solvent | 66 |
| 15 | Purified water | Water | 96.3 |

### Example 1

In a Griffin beaker with a volume of 200 ml, 10 g of sodium dodecylbenzenesulfonate (trade name “NEOPELEXG-25”, manufactured by Kao Corporation) as an anionic surfactant, and 90 g of Japanese Pharmacopoeia purified water were mixed at room temperature of 25° C. to prepare 100 g of a preparation. Subsequently, the preparation was stirred and mixed until being homogeneous while heating the preparation in a water bath at 40° C. indirectly, and then the resultant preparation was allowed to cool down to obtain a lice eliminator.

### Example 2

A lice eliminator was obtained in a similar manner as in Example 1 except that 10 g of a coconut oil fatty acid potassium liquid and glycerin mixture (trade name “COSMETIC SOAP DCK-4N”, manufactured by MIYOSHI OIL & FAT CO., LTD.) was used as the anionic surfactant.

### Example 3

A lice eliminator was obtained in a similar manner as in Example 1 except that 10 g of lauryl trimethyl ammonium chloride (trade name “QUARTAMIN 24P”, manufactured by Kao Corporation) was used as the cationic surfactant.

### Example 4

A lice eliminator was obtained in a similar manner as in Example 1 except that 10 g of coconut amine acetate (trade name “ACETAMIN 24”, manufactured by Kao Corporation) was used as the cationic surfactant.

### Example 5

A lice eliminator was obtained in a similar manner as in Example 1 except that 10 g of alkyl (8 to 18 carbon atoms) dimethylamine oxide (trade name “CADENAX DMCW-I”, manufactured by Lion Corporation) was used as the amphoteric surfactant.

### Example 6

A lice eliminator was obtained in a similar manner as in Example 1 except that 10 g of 2-alkyl-N-carboxymethyl-N-hydroxyethyl imidazolium betaine (trade name “AMPHOREX 30S”, manufactured by MIYOSHI OIL & FAT CO., LTD.) was used as the amphoteric surfactant.

### Example 7

A lice eliminator was obtained in a similar manner as in Example 1 except that 10 g of polyoxyethylene lauryl ether (trade name “EMULGEN 109P”, manufactured by Kao Corporation) was used as the nonionic surfactant.

### Example 8

A lice eliminator was obtained in a similar manner as in Example 1 except that 10 g of polyethylene glycol lauryl ether (trade name “EMANON 1112”, manufactured by Kao Corporation) was used as the nonionic surfactant.

### Example 9

A lice eliminator was obtained in a similar manner as in Example 1 except that 10 g of monolauric acid polyethylene glycol (trade name “NONION L-4”, manufactured by NOF CORPORATION) was used as the nonionic surfactant.

### Example 10

A lice eliminator was obtained in a similar manner as in Example 1 except that 25 g of a coconut oil fatty acid potassium liquid and glycerin mixture (trade name “COSMETIC SOAP DCK-4N”, manufactured by MIYOSHI OIL & FAT CO., LTD.) as the anionic surfactant, and 75 g of purified water were used.

### Example 11

A lice eliminator was obtained in a similar manner as in Example 1 except that 2 g of lauryl trimethyl ammonium chloride (trade name “QUARTAMIN 24P”, manufactured by Kao Corporation) as the cationic surfactant, and 98 g of purified water were used.

### Example 12

A lice eliminator was obtained in a similar manner as in Example 1 except that 5 g of sodium dodecylbenzenesulfonate (trade name “NEOPELEXG-25”, manufactured by Kao Corporation) as the anionic surfactant, and 5 g of polyethylene glycol lauryl ether (trade name “EMANON 1112”, manufactured by Kao Corporation) as the nonionic surfactant were used.

### Example 13

A lice eliminator was obtained in a similar manner as in Example 1 except that 5 g of lauryl trimethyl ammonium chloride (trade name “QUARTAMIN 24P”, manufactured by Kao Corporation) as the cationic surfactant, 25 g of ethanol, and 75 g of purified water were used.

### Example 14

A lice eliminator was obtained in a similar manner as in Example 1 except that 2 g of sodium lauryl sulfate (trade name “EMAL 0”, manufactured by Kao Corporation) as the anionic surfactant, and 8 g of alkyl (8 to 18 carbon atoms) dimethylamine oxide (trade name “CADENAX DMCW-I”, manufactured by Lion Corporation) as the amphoteric surfactant were used.

### Example 15

A lice eliminator was obtained in a similar manner as in Example 1 except that 2 g of sodium lauryl sulfate (trade name “EMAL 0”, manufactured by Kao Corporation) as the anionic surfactant, 8 g of alkyl (8 to 18 carbon atoms) dimethylamine oxide (trade name “CADENAX DMCW-I”, manufactured by Lion Corporation) as the amphoteric surfactant, and 2 g of lauric acid diethanolamide (trade name “AMINON L-02”, manufactured by Kao Corporation) for the purpose of the thickening were used.

### Example 16

A lice eliminator was obtained in a similar manner as in Example 1 except that 0.5 g of sodium lauryl sulfate (trade name “EMAL 0”, manufactured by Kao Corporation) as the anionic surfactant, and 0.5 g of alkyl (8 to 18 carbon atoms) dimethylamine oxide (trade name “CADENAX DMCW-I”, manufactured by Lion Corporation) as the amphoteric surfactant were used.

### Example 17

A lice eliminator was obtained in a similar manner as in Example 1 except that 5 g of sodium lauryl sulfate (trade name “EMAL 0”, manufactured by Kao Corporation) as the anionic surfactant, and 20 g of alkyl (8 to 18 carbon atoms) dimethylamine oxide (trade name “CADENAX DMCW-I”, manufactured by Lion Corporation) as the amphoteric surfactant were used.

### Example 18

A lice eliminator was obtained in a similar manner as in Example 1 except that 3 g of sodium lauryl sulfate (trade name “EMAL 0”, manufactured by Kao Corporation) as the anionic surfactant, and 30 g of alkyl (8 to 18 carbon atoms) dimethylamine oxide (trade name “CADENAX DMCW-I”, manufactured by Lion Corporation) as the amphoteric surfactant were used.

### Comparative Example 1

A composition was obtained in a similar manner as in Example 1 except that 10 g of N-coconut oil fatty acid acyl-L-alanine sodium solution (trade name “AMILITE ACS-12”, manufactured by Ajinomoto Co., Inc.) being an anionic surfactant was used.

### Comparative Example 2

A composition was obtained in a similar manner as in Example 1 except that 10 g of sodium methyl cocoyl taurate (trade name “DIAPON K-SF”, manufactured by NOF CORPORATION) being a cationic surfactant was used.

### Comparative Example 3

A composition was obtained in a similar manner as in Example 1 except that 10 g of polyoxyethylene hydrogenated castor oil)(40E.O. (trade name “EMANON CH40”, manufactured by Kao Corporation) being a nonionic surfactant was used.

### Comparative Example 4

A composition was obtained in a similar manner as in Example 1 except that 10 g of propylene glycol was used in place of the surfactant.

### Comparative Example 5

A composition was obtained in a similar manner as in Example 1 except that 100 g of purified water was used in place of the surfactant.

By using the compositions obtained in Examples 1 to 18, and Comparative Examples 1 to 5, evaluations of the performances regarding the louse precipitation rate and the extermination rate were made.

[Louse Precipitation Rate]

The compositions obtained in Examples 1 to 18 and Comparative Examples 1 to 5 were each placed in a deep Petri dish, and when foam occurred on the liquid surface, the foam was removed. After that, 20 live body lice (Pediculus humanus corporise DE GEER) were picked up with tweezers and dropped one by one onto a liquid surface of each composition. The dropped lice were left to stand for 5 minutes as they were, and then a proportion to be obtained by dividing the number of the lice of which the head, chest, and abdomen had been all precipitated completely in the liquid by the total number of the lice dropped to the liquid was calculated by equation (1). As a result, the louse precipitation rates for the compositions obtained in Examples 1 to 18 were 54 to 100%, but the louse precipitation rates for the compositions obtained in Comparative Examples 1 to 5 were 0 to 20%.

[Extermination Rate]

With respect to the compositions obtained in Examples 1 to 18 and Comparative Examples 1 to 5, in order to measure the louse precipitation rate, lice were dropped to a deep Petri dish in which each of the compositions had been put and taken each of the lice out of the deep Petri dish, the composition adhered to the body surface of each of the lice was washed off, and the lice were left to stand for 12 hours. After standing for 12 hours, the lice that were motionless were counted as being exterminated, the extermination rate of lice was calculated as a proportion in percentage with respect to the total number of the lice dropped in the deep Petri dish for the measurement of the louse precipitation rate. As a result, with the compositions obtained in Examples 1 to 18, the extermination rate was 62 to 100% and lice were able to be exterminated, but with the compositions obtained in Comparative Examples 1 to 5, the extermination rate was 0 to 10% and lice were not able to be exterminated.

These results are shown in Tables 2, 3, and 4.

TABLE 2

| | | Example 1 | Example 2 | Example 3 | Example 4 | Example 5 | Example 6 | Example 7 | Example 8 |
|---|---|---|---|---|---|---|---|---|---|
| [symbol] | [symbol] | 10 | | | | | | | |
| | [symbol] | | 10 | | | | | | |
| [symbol] | [symbol] | | | 10 | | | | | |
| | [symbol] | | | | 10 | | | | |
| [symbol] | [symbol] | | | | | 10 | | | |
| | [symbol] | | | | | | 10 | | |
| [symbol] | [symbol] | | | | | | | 10 | |
| | [symbol] | | | | | | | | 10 |
| | [symbol] | | | | | | | | |
| [symbol] | [symbol] | | | | | | | | |
| | [symbol] | 90 | 90 | 90 | 90 | 90 | 90 | 90 | 90 |

| | | | | | | | | |
|---|---|---|---|---|---|---|---|---|
| [symbol] | 100 | 100 | 100 | 100 | 100 | 100 | 100 | 100 |
| [symbol] | [symbol] 0 | 80 | 100 | 75 | 75 | 70 | [symbol] | 80 |
| [symbol] | 100 | 95 | 9 [symbol] | [symbol] | 7 [symbol] | 100 | 6 [symbol] | 6 [symbol] |

| | | Example 9 | Example 10 | Example 11 | Example 12 | Example 13 |
|---|---|---|---|---|---|---|
| [symbol] | [symbol] | | | | [symbol] | |
| | [symbol] | | 25 | | | |
| [symbol] | [symbol] | | | 2 | | [symbol] |
| | [symbol] | | | | | |
| [symbol] | [symbol] | | | | | |
| | [symbol] | | | | | |
| [symbol] | [symbol] | | | | | |
| | [symbol] | | | | 5 | |
| | [symbol] | 10 | | | | |
| [symbol] | [symbol] | | | | | 20 |
| | [symbol] | 90 | 75 | 98 | 90 | 75 |

| | | | | | |
|---|---|---|---|---|---|
| [symbol] | 100 | 100 | 100 | 100 | 100 |
| [symbol] | 75 | [symbol] | 54 | 90 | 9 [symbol] |
| [symbol] | 7 [symbol] | 10 [symbol] | 62 | [symbol] 0 | 80 |

[symbol]

indicates data missing or illegible when filed

TABLE 3

| | | Example 14 | Example 15 | Example 16 | Example 17 | Example 18 |
|---|---|---|---|---|---|---|
| Anionic surfactant | Sodium | | | | | |
| | dodecylbenzenesulfonate | | | | | |
| | Coconut oil fatty acid | | | | | |
| | potassium liquid + glycerin | | | | | |
| | Sodium lauryl sulfate | 2 | 2 | 0.5 | 5 | 3 |
| | Lauric acid diethanolamide | | 2 | | | |
| Cationic surfactant | Lauryl trimethyl ammonium | | | | | |
| | chloride | | | | | |
| | Coconut amine acetate | | | | | |
| Amphoteric surfactant | Alkyl (having 8 to 18 carbon | 8 | 8 | 0.5 | 20 | 30 |
| | atoms) dimethylamine oxide | | | | | |
| | 2-Alkyl-N-carboxymethyl-N- | | | | | |
| | hydroxyethyl imidazolinium | | | | | |
| | betaine | | | | | |
| Nonionic surfactant | Polyoxyethylene lauryl ether | | | | | |
| | Polyethylene glycol monolaurate | | | | | |
| | Monolauric acid polyethylene | | | | | |
| | glycol | | | | | |
| Solvent | Ethanol | | | | | |
| | Purfied water | 90 | 88 | 99 | 75 | 67 |

| | | | | | |
|---|---|---|---|---|---|
| Total (% by weight) | 100 | 100 | 100 | 100 | 100 |
| Louse precipitation rate (%) to agent | 100 | 100 | 100 | 80 | 100 |
| Extermination rate | 100 | 95 | 80 | 100 | 100 |

TABLE 4

| | | Comparative | Comparative | Comparative | Comparative | Comparative |
|---|---|---|---|---|---|---|
| | | Example 1 | Example 2 | Example 3 | Example 4 | Example 5 |
| Anionic surfactant | N-Coconut oil fatty acid acyl- | 10 | | | | |
| | L-alanine sodium solution | | | | | |
| Cationic surfactant | Sodium methyl cocoyl taurate | | 10 | | | |
| Nonionic surfactant | Polyoxyethylene | | | 10 | | |
| | hydrogenerated castor oil | | | | | |
| | [symbol] | | | | | |
| Solvent | Polypropylene glycol | | | | 10 | |
| Water | Purified water | 90 | 90 | 90 | 90 | 100 |

| | | | | | |
|---|---|---|---|---|---|
| Total (% by weight) | 100 | 100 | 100 | 100 | 100 |
| Louse precipitation rate (%) to agent | 20 | 10 | 15 | 10 | 0 |
| Extermination rate | 0 | 10 | 0 | 0 | 0 |

[symbol]

indicates data missing or illegible when filed

As shown in Tables 1 to 4, in Examples 1 to 18, the louse precipitation rates are in the predetermined range, and further, the contact angles to a solid matter are in the predetermined range, and therefore, the liquid of each of the compositions is easily taken onto a louse when adhered to the louse, and 60% or more of the 20 lice, which had been subjected to the measurement of the louse precipitation rate, was able to be exterminated, and in Comparative Examples 1 to 5, the lice were not able to be sufficiently exterminated. From these results, it has been revealed that a lice eliminator exhibiting predetermined properties exerts a high extermination effect on lice.

What is claimed is:

1. A lice eliminator having a louse precipitation rate of 50 to 100%, wherein
the louse precipitation rate is a proportion in percentage of lice precipitating completely into the lice eliminator with respect to lice dropped onto the lice eliminator when a plurality of lice is dropped onto the lice eliminator.

2. The lice eliminator according to claim 1, wherein
the lice eliminator contains a spreading component having a contact angle of 1 to 60°.

3. The lice eliminator according to claim 2, wherein
the spreading component is a surfactant.

4. The lice eliminator according to claim 2 or 3, wherein
the spreading component is at least one of a cationic surfactant, an anionic surfactant, an amphoteric surfactant, or a nonionic surfactant.

5. The lice eliminator according to claim 2 or 3, wherein
the spreading component is two selected from an anionic surfactant, an amphoteric surfactant, or a nonionic surfactant.

6. The lice eliminator according to claim 2 or 3, wherein
the spreading component is an anionic surfactant and an amphoteric surfactant.

7. The lice eliminator according to claim 2 or 3, wherein
the spreading component is contained at 0.1 to 80% by weight.
